(19) United States
(12) Patent Application Publication
(10) Pub. No.: US 2002/0052188 A1
(43) Pub. Date: May 2, 2002

(54) System and method to use a wired network to extend radio coverage of a wireless network

(76) Inventor: Farbod Behbahani, Santa Ana, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/021,339

(22) Filed: Oct. 30, 2001

Related U.S. Application Data
(60) Provisional application No. 60/245,179, filed on Nov. 1, 2000.

(51) Int. Cl. H04M 9/00; H04B 7/14

(52) U.S. Cl. 455/402; 455/20; 455/42

(57) ABSTRACT

A system and method to use a wired network to extend radio coverage of a wireless network is described. With respect to one embodiment, the method comprises converting incoming wireless signals sent by a wireless unit to intermediate frequency (IF) signals. The method further comprises transmitting the converted IF signals over a wired network and retrieving the transmitted IF signals from the wired network. In addition, the method comprises converting the retrieved IF signals to digital data that can be routed to a destination.

### RELATED APPLICATION

This application claims the benefit U.S. Provisional Patent Application No. 60/245,179, entitled “System and Method to Use a Wired Network to Extend Radio Coverage of a Wireless Network”, filed on Nov. 1, 2000 (Attorney Docket No. 003297.P003Z).

### FIELD

The invention relates to the field of networking. In particular, one embodiment of the invention relates to a system and method to use a wired network to extend radio coverage of a wireless network.

### GENERAL BACKGROUND

Wireless telephony and data systems are often utilized when it is not practical to use wiring to allow connectivity, or when mobility is needed. Wireless systems generally have some shortfalls.

Wireless systems still generally rely on some wire media (e.g., copper lines, coaxial cable lines, power lines, fiber optic lines, etc.) to transport signals to base stations, sometimes referred to as “Access Points,” in the wireless systems. If a wireless system requires a large number of distributed Access Points, the system can require a substantial amount of wire media. Therefore, it would be desirable to capitalize on a wiring infrastructure that is already in existence. If existing wiring infrastructure could be utilized by a newly installed wireless system, the time and costs required to install that system would be reduced.

Furthermore, radio coverage or range in most residential and in-building environments is practically limited due to absorption and reflection characteristics. The radio coverage or range is generally to less than 100 feet when high radio frequencies, such as 2.4 gigahertz (GHz) or 5.8 GHz for example, are used to transport high data rates (e.g., greater than one megabit per second “1 Mb/s”). Therefore, it would be advantageous to extend the radio coverage or range.

It may also be desirable to organize the process of reception, manipulation, and transmission of radio signals to reduce the number of components, e.g., transceivers, to reduce costs.

### BRIEF DESCRIPTION OF THE DRAWINGS

FIG. 1 is a conventional, prior art system.

FIG. 2 shows an exemplary wireless networking system in accordance with one embodiment of the invention.

FIG. 3 is an exemplary embodiment of an Access Point of FIG. 2.

FIG. 4 is an exemplary flowchart outlining an embodiment of the process of signals reception, transmission, and manipulation in accordance with one embodiment of the invention.

FIG. 5 is an exemplary flowchart outlining an embodiment of the process of signals reception, transmission, and manipulation in accordance with another embodiment of the invention.

### DETAILED DESCRIPTION

The invention generally relates to a system and method to use a wired network to extend radio coverage of a wireless network. For instance, one embodiment of the method includes converting incoming radio frequency (RF) signals sent by a wireless unit to intermediate frequency (IF) signals. The converted IF signals are transmitted over a wired network, which are retrieved and converted to digital data that can be routed to a destination.

In the following description, certain terminology is used to describe features of the invention. For example, “logic” includes hardware and/or software module(s) that perform a certain function on incoming information. A software “module” is generally defined as one or more instructions (e.g., executable code) such as an operating system, an application, an applet, a program, a subroutine or the like. “Information” can be data, address, control or any combination thereof. Of course, voice and video are types of data. For transmission, the information can be placed in a frame featuring a single data packet or a series of data packets. A “link” can be broadly defined as one or more information-carrying physical media to establish a communication pathway.

Moreover, a “wireless unit” is generally defined herein as any electronic device comprising processing logic (e.g., a processor, micro-controller, state machine, etc.) and a wireless transceiver for transmitting and receiving data to and from an Access Point or another wireless unit. Examples of a wireless unit include a computer (e.g., desktop computer, laptop computer, hand-held computer such as a personal digital assistant “PDA”, etc.), or communications equipment (e.g., pager, cellular telephone, facsimile machine, etc.). An “Access Point” is a device that provides either unidirectional to or bi-directional connection between one or more wireless units and wired backbone network 140.

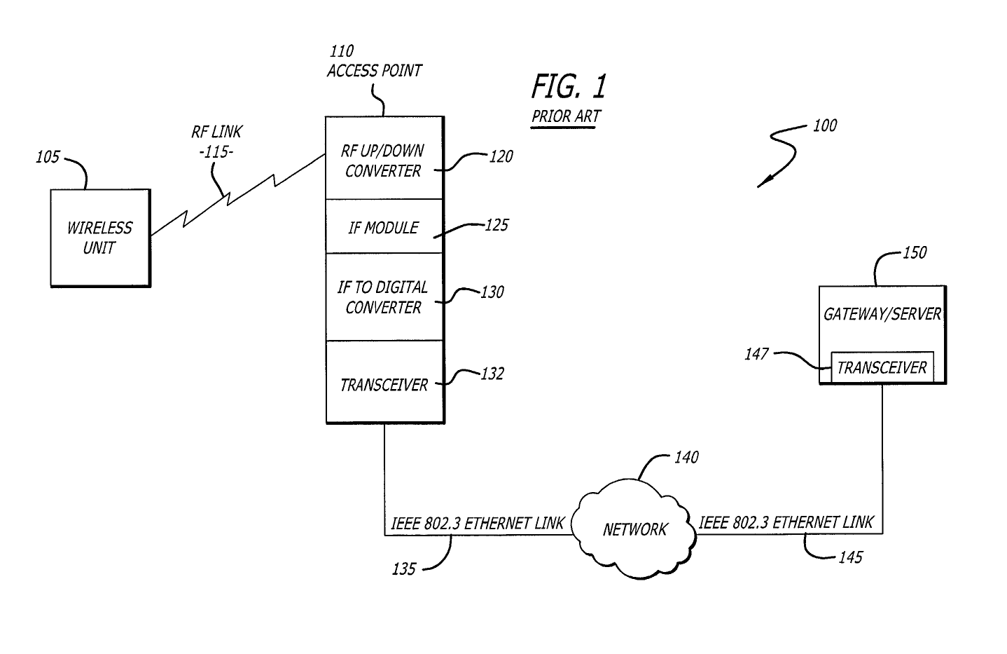

FIG. 1 illustrates a conventional prior art system 100. The prior art system 100 includes wireless unit 105 that transmits information to an Access Point 110 using radio frequency (RF) signals over RF link 115. Access Point 110 receives RF signals from wireless unit 105 and uses a RF up/down converter 120 to convert the RF signals to intermediate frequency (IF) signals. Access Point 110 uses an IF-to-Digital converter 130 to convert the IF signals into digital data and to format the digital data in accordance with IEEE (Institute of Electrical and Electronic Engineers) 802.3 standards. Differing in format from the incoming RF signals, the formatted digital data is sent to a wired backbone network 140 over IEEE 802.3 Ethernet link 135. Network 140 routes the formatted digital data over IEEE 802.3 Ethernet link 145 to a gateway or server 150.

It should be noted that since Access Point 110 communicates with gateway 150 using IEEE 802.3 Ethernet data over IEEE 802.3 Ethernet link 145, Access Point 110 and gateway 150 will have to respectively include transceivers 132 and 147 capable of transmitting and receiving IEEE 802.3 Ethernet data. Inclusion of the transceivers 132 and 147 increases the costs of Access Point 110 and gateway 150 in particular, and the costs of the entire system 100 in general.

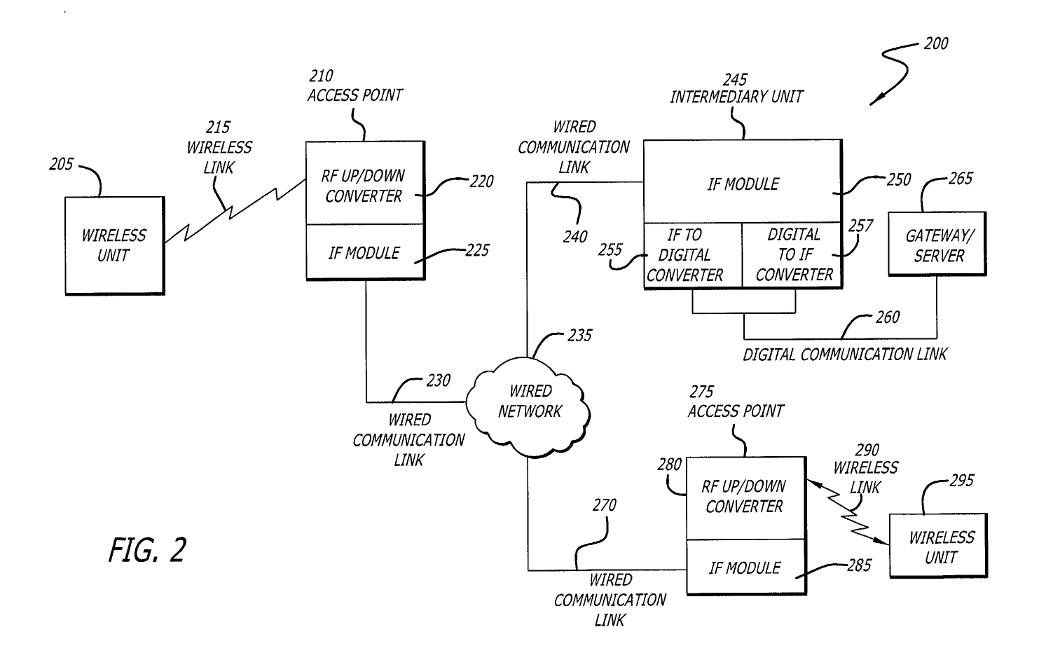

Referring now to FIG. 2, an exemplary embodiment of a wireless networking system 200 is shown. Wireless networking system 200 includes a wireless unit (WU) 205 adapted to transmit information to Access Point 210 over a wireless link 215. In principle, the wireless link 215 can generally support transmissions of various types of wireless signals. For instance, in the illustrated embodiment, the information may be transmitted as radio frequency (RF) signals over a RF link. In an alternative embodiment, the wireless link 215 can be an infrared link conducive to transmission of information using infrared signals.

Access point 210 receives RF signals from wireless unit 205 and uses logic, referred to as a RF up/down converter 220, to convert the RF signals to intermediate frequency (IF) signals. The RF up/down converter 220 performs the RF-to-IF conversion so that at least (1) the signals can be sent over a wired communication link 230, and (2) the signals can be converted to digital data at a later time. IF signals are generally analog signals used to propagate digital data or voice packets. In general, the IF signals carry the same information or data content as the incoming RF signals and enable greater throughput to be realized over a wired communication links and/or wired network backbone described below.

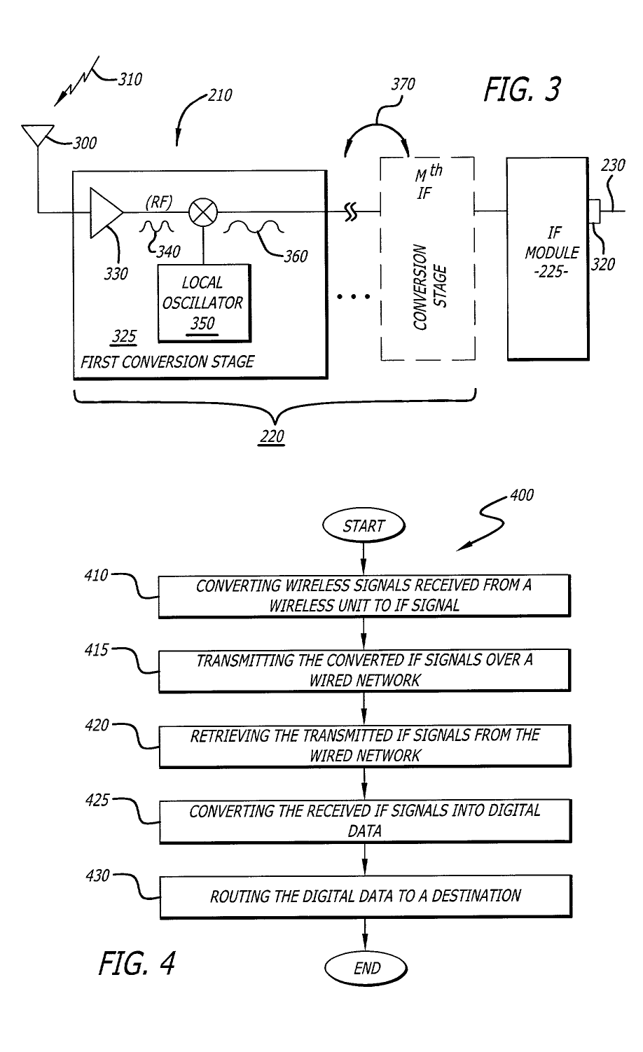

As shown in FIG. 3, the Access Point 210 comprises an antenna 300 to receive an RF signal 310 and a connector 320 to output the resultant IF signals over wireless communication link 230. Herein, it is contemplated that the connector 320 may include an electrical plug (e.g., 2 or 3 prong plug) where the wired communication link 230 can be any kind of wired media, such as AC electrical wiring, RJ-11 adaptable or other type of telephone plug for a RJ-11 or other type of telephone jack where the wired communication link 230 is telephone wiring, and the like.

RF up/down converter 220 of Access Point 210 includes one or more conversion stages. For instance, Access Point 210 receives the RF signal 310 from antenna 300 and routes the RF signal 310 to a first IF conversion stage 325. Herein, the incoming RF signal 310 is amplified using an amplifier 330. The amplified RF signal 340 is down converted based on an intermediate frequency set by a local oscillator 350 for example. This produces an IF signal 360 as shown. Of course, filters may be used to filter at least one of the RF signal 310, the amplified RF signal 340 and resultant IF signal 360. Also, optionally as shown by dashed lines, successive IF conversion stages 370 may be implemented within RF up/down converter 220 to produce an IF signals, such as a baseband IF signal for example, before transmission over wired communication link 230.

Referring back to FIG. 2, following the RF-to-IF conversion, Access Point 210 uses logic, referred to as an IF module 225, to send the IF signals over wired communication link 230, a wired backbone network 235, and another wired communication link 240 to intermediary unit 245. IF module 225 can include (but not limited to) signal conditioning functions such as filtering and amplification. Wired communication links 230, 240 can be a physical medium such as an alternating current (AC) power line, a telephone line such as a twisted pair or another type of electrical wiring, a coaxial or optical cable, or the like.

Intermediary unit 245 is logic, perhaps featured as an electronic device, adapted to receive IF signals transmitted by Access Point 210, to convert the incoming IF signals to digital data, and to format the digital data. Intermediary unit 245 features a connector that, in combination with an IF module 250, receives incoming IF signals transmitted by Access Point 210. The connector may include an electrical plug (2 or 3 prong), RJ-11 or other telephone plug for a RJ-11 or other type of telephone jack, etc. IF module 250 is generally a receiver that can include (but not limited to) functions such as filtering, amplification, Analog-to-Digital conversion, and Digital-to-Analog conversion. Intermediary unit 245 uses an IF-to-Digital converter 255 to convert the IF signals to digital data and also to format the digital data. The formatted digital data can then be sent over digital communication link 260 to a gateway or server 265. Digital communication link 260 can be a physical medium such as an AC power line, telephone line or other electrical wire, a cable, a copper line, or the like. This physical medium can communicate using one of many communication protocols, including IEEE 802.3 Ethernet, Asynchronous Transfer Mode (ATM), Token Ring, or the like.

In one embodiment, IF-to-Digital converter 255 formats digital data in accordance to IEEE 802.3 for instance, so that the formatted digital data can be transmitted over a digital communication link 260 that can support IEEE 802.3 Ethernet. In another exemplary embodiment, IF-to-Digital converter 255 formats digital data in accordance with ATM so that the formatted digital data, namely ATM cells, can be transmitted over a digital communication link that supports ATM. In short, the functionality of IF-to-Digital converter 255 can be expanded to support various communication protocols at the physical layer.

Concurrently with or alternative to the operations by the intermediary unit 245, the IF signals may be routed to another Access Point 275. Access point 275 comprises logic, namely an IF module 285, to receive incoming IF signals routed over wired communication link 230 and wired network 235. Access point 275 uses RF up/down converter logic 280 to convert the IF signals into wireless signals for transmission to a wireless unit (WU) 295 over a wireless link 290. In principle, the wireless link 290 can generally support transmissions of various types of wireless signals. For instance in the illustrated embodiment, the wireless link 290 can be a RF link conducive to transmission of information using RF signals. In an alternative embodiment, the wireless link 290 can be an infrared link conducive to transmission of information using infrared signals.

In the wireless networking system 200 of FIG. 2, the gateway or server 265 can transmit information to wireless units 205 and 295. Gateway or server 265 can transmit digital data to intermediary unit 245 via digital communication link 260. As previously described, digital communication link 260 can be a physical medium such as an AC power line, telephone line or other electrical wire, a cable, a copper line, or the like. Digital communication link 260 can communicate using one of many communication protocols, including IEEE 802.3 Ethernet, Asynchronous Transfer Mode (ATM), Token Ring, or the like.

Intermediary unit 245 uses Digital-to-IF converter 257 to convert the digital data to IF signals. IF module 225 can then send the converted IF signals over wired communication link 240 to the wired network 235. From the wired network 235, the IF signals can be routed to wireless unit 205 through Access Point 210 or to wireless unit 295 through Access Point 275. Access Points 210 and 275 include IF modules 225 and 285 and RF up/down converters 220 and 280, respectively. Access Points 210 and 275 use the IF modules 225 and 285 to receive IF signals that the intermediary unit 245 transmits over the wired network 235. Access Points 210 and 275 use the RF up/down converters 220 and 280 to convert IF signals to wireless signals. Access Points 210 and 275 then send the wireless signals respectively to wireless units 205 and 295 over wireless links 215 and 290.

Referring now to FIG. 4, an exemplary flowchart 400 outlining the process of receiving, transmitting, and manipulating signals in accordance with one embodiment of the invention is shown. In block 410, wireless signals transmitted by a wireless unit are received and converted into intermediate frequency (IF) signals. The originally transmitted wireless signals may be RF signals. In block 415, the converted IF signals are then transmitted over a wired network to an intermediary unit, which is shown as element 245 in FIG. 2 and described in the text accompanying the figure. The transmitted IF signals are retrieved from the wired network (block 420), and are converted into digital data (block 425). In block 430, the digital data is formatted in accordance with a communication protocol at the physical layer, and is then routed to a destination. Of course, it is contemplated that the formatting of the digital data may be handled at the data link layer in accordance with an Open Systems Interconnection (OSI) model.

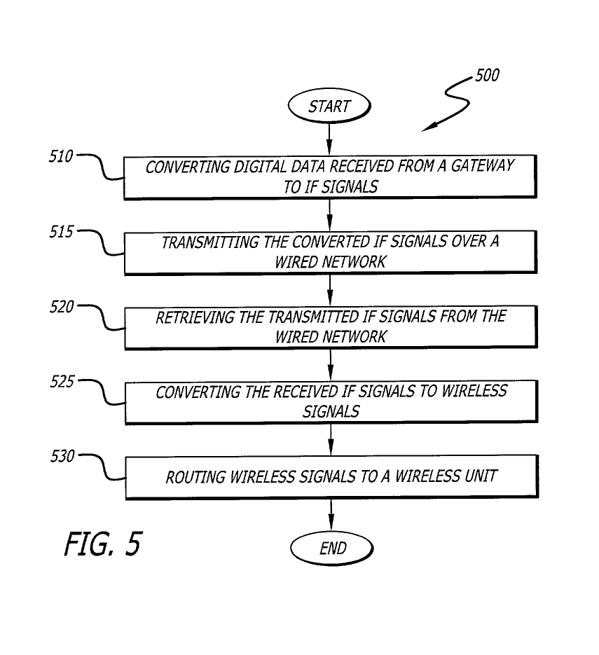

Referring now to FIG. 5, an exemplary flowchart 500 outlining the process of receiving, transmitting, and manipulating signals in accordance with another embodiment of the invention is shown. In block 510, digital data transmitted by a gateway are received and converted into intermediate frequency (IF) signals. In block 515, the converted IF signals are then transmitted over a wired network to an intermediary unit, which is shown as element 245 in FIG. 2 and the described in the text accompanying the figure. The transmitted IF signals are retrieved from the wired network (block 520), and are converted into wireless signals (block 525). In one embodiment, the wireless signals can be RF signals. In block 530, the wireless signals are routed to a wireless unit.

While certain exemplary embodiments have been described and shown in the accompanying drawings, it is to be understood that such embodiments are merely illustrative of and not restrictive on the broad invention, and that the spirit and scope of the invention should not be limited to the specific constructions and arrangements shown and described.

What is claimed is:

1. A method for transmitting information over a wireless network, comprising:
converting incoming wireless signals to intermediate frequency (IF) signals;
transmitting the converted IF signals over a wired network;
retrieving the transmitted IF signals from the wired network; and
converting the retrieved IF signals to digital data that can be routed to a destination.

2. The method of claim 1, wherein the converting of the incoming wireless signals includes converting radio frequency (RF) signals to IF signals.

3. The method of claim 1, wherein the wired network includes alternating current (AC) wiring.

4. The method of claim 3, wherein the IF signals are baseband signals.

5. The method of claim 1, wherein the destination is at least one of a gateway and server.

6. An Access Point comprising:
a radio frequency (RF) up/down converter to convert RF signals to intermediate frequency (IF) analog signals; and
an IF module to transmit the IF analog signals over a wired communication link for subsequent conversion into digital data at the destination.

7. The Access Point of claim 6, wherein the wired communication link is alternating current (AC) electrical wiring.

8. The Access Point of claim 6, wherein the wired communication link is a twisted pair telephone line.

9. The Access Point of claim 6 further comprising an antenna to receive the RF signals.

10. An Access Point comprising:
a first software module operating as an up/down converter to convert wireless signals to intermediate frequency (IF) analog signals; and
a second software module operating in conjunction with the first software module to transmit the IF analog signals over a wired communication link for subsequent conversion into digital data at the destination.

11. The Access Point of claim 10, wherein the wired communication link is alternating current (AC) electrical wiring.

12. The Access Point of claim 10, wherein the wired communication link is a twisted pair telephone line.

13. The Access Point of claim 10 further comprising an antenna to receive the RF signals.

14. The Access Point of claim 10, wherein the up/down converter is a radio frequency (RF) up/down converter to convert RF signals into the IF analog signals.

15. An intermediary unit comprising:
a connector coupled to a wired communication link;
an intermediary frequency (IF) module to receive incoming IF signals over the wired communication link; and
an IF-to-Digital converter to convert the incoming IF signals to digital data and format the digital data according to a format associated with a digital communication link.

16. The intermediary unit of claim 15, wherein the connector is an electrical plug based on the wired communication link being electrical wiring.

17. The intermediary unit of claim 15, wherein the connector is a telephone plug for insertion into a telephone jack based on the wired communication link being a telephone line.

18. The intermediary unit of claim 15, wherein the IF-to-Digital converter formats the digital data according to an Ethernet format based on the digital communication link being an Ethernet communication link.

19. An intermediary unit comprising:
a connector coupled to a wired communication link;
an IF-to-Digital converter to receive incoming digital data sent over a digital communication link, and convert the incoming digital data to IF signals; and
an intermediary frequency (IF) module to send the IF signals over the wired communication link to a wired network.

20. The intermediary unit of claim 19, wherein the connector is an electrical plug based on the wired communication link being electrical wiring.

21. The intermediary unit of claim 19, wherein the connector is a telephone plug for insertion into a telephone jack based on the wired communication link being a telephone line.

22. A method for transmitting information over a wireless network, comprising:
converting incoming digital data to intermediate frequency (IF) signals;
transmitting the converted IF signals over a wired network;
retrieving the transmitted IF signals from the wired network; and
converting the retrieved IF signals to wireless signals that can be routed to a wireless unit.

23. The method of claim 22, wherein the converting of the retrieved IF signals includes converting the retrieved IF signals to radio frequency (RF) signals.

24. The method of claim 22, wherein the wired network includes alternating current (AC) wiring.
